(19) United States
(12) Patent Application Publication
(10) Pub. No.: US 2015/0051988 A1
(43) Pub. Date: Feb. 19, 2015

(54) DETECTING MARKETING OPPORTUNITIES BASED ON SHARED ACCOUNT CHARACTERISTICS SYSTEMS AND METHODS

(71) Applicant: Hui-Min Chen, San Jose, CA (US)

(72) Inventor: Hui-Min Chen, San Jose, CA (US)

(21) Appl. No.: 13/968,131

(22) Filed: Aug. 15, 2013

(51) Int. Cl. G06Q 30/02

(52) U.S. Cl. CPC G06Q 30/0277
USPC 705/14.73

(57) ABSTRACT

There is provided systems and method for detecting marketing opportunities based on shared account characteristics. The methods include receiving an account characteristic corresponding to an account of a user, determining at least a second account sharing the account characteristic, and associating the account of the user with the at least second account to form an account cluster corresponding to the account characteristic. The methods may further include transmitting at least one of an advertisement, a coupon, and a sale offer to the account of the user and the at least second account.

### BACKGROUND

1. Technical Field

The present application generally relates to detecting marketing opportunities based on shared account characteristics and more specifically to collecting similar user accounts into account clusters based on shared characteristics in order to provide marketing and advertising to similar accounts.

2. Related Art

User may access many different accounts in any given day to engage in online transactions. Users may set up email, payment, or other accounts, each with a separate identifier. These users may knowingly or otherwise provide information to the account providers that may be utilized to target specific marketing to the users. For example, based on a user's spending habits using a payment account with a payment provider, specific merchandise offers may be provided to the user. However, the user may only receive targeted marketing information, such as advertisements, sales, and coupons, at some or none of the accounts based on information provided to the account providers and/or separate websites. Even if the user does receive the marketing information on at least one account, the user may not view the information in time, or may ignore the information based on the specific account or the account settings. Thus, the user will not be privy to particular marketing information the user may desire.

### BRIEF DESCRIPTION OF THE DRAWINGS

FIG. 1 is a block diagram of a networked system suitable for implementing the process described herein according to an embodiment;

FIG. 2 is a marketing server database including account clusters with shared characteristics;

FIG. 3 is a flowchart of an exemplary process by a marketing server for marketing opportunities to account clusters with shared characteristics; and

FIG. 4 is a block diagram of a computer system suitable for implementing one or more components in FIG. 1 according to one embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

In certain embodiments, a marketing server may work in connection with one or more merchant servers, payment provider servers, email account servers, or other user account providers to determine one or more account clusters based on one or more user accounts sharing a feature, information, identifier, or other characteristic. The accounts may belong to the same user, thus associating accounts of a single user in an account cluster. However, in other embodiments, the accounts may belong to a plurality of users sharing the account characteristic, such as general area (e.g. zip code or city). The marketing server, which may be separate from the other servers/providers or may be associated with or part of one of the other servers/providers, such as a payment provider, may choose or receive a specific account characteristic of a first user account. Using the account characteristic, additional user accounts belonging to a user or entity may be detected and collected into an account cluster based on a shared characteristic. User accounts in the account cluster may receive targeted marketing information, such as advertisements, coupons, and sales offers. Additionally, providers of the user accounts may enable or disable specific features associated with the user accounts based on the shared characteristic. Behavior and information of the user accounts in the account cluster may be used to determine further account clusters.

In one embodiment, a user or entity sets up an account with an account provider and submits various amounts of user information. The user information may also be collected by the account provider and/or a marketing server. For example, credit card, debit card, physical location (e.g. a home address, city, and/or country), and/or bank account information may be entered by a user when setting up and/or managing a user account. Additionally, the account provider or other entity may collect information associated with the account, such as an IP address of a device used to access the user account and/or a machine cookie. The user account may additionally perform transactions with a specific service provider and/or may share another account on a domain, for example, by providing payment services to one account on a merchant server. Using one or more of these account characteristics, an account cluster may be formed by finding other accounts sharing the account characteristics. The account cluster may be utilized to provide targeted advertisements or other marketing opportunities. Additionally, further account clusters may be formed with other user accounts based on information extracted from the first formed account cluster.

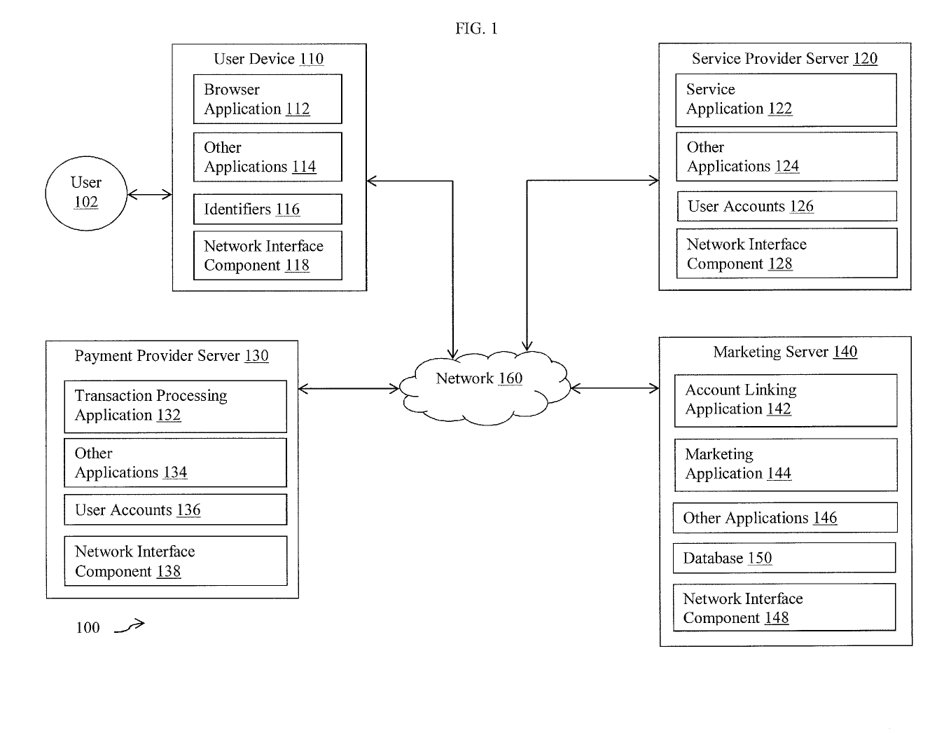

FIG. 1 is a block diagram of a networked system 100 suitable for implementing the process described herein according to an embodiment. As shown, system 100 may comprise or implement a plurality of devices, servers, and/or software components that operate to perform various methodologies in accordance with the described embodiments. Exemplary device and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a user 102 utilizing a user device 110 with a service provider server 120, a payment provider server 130, and a marketing server 140 over a network 160. User 102, such as a consumer, utilizes user device 110 to establish user accounts with various service and payment providers. These actions may be facilitated by service provider server 120 and/or payment provider server 130 in certain embodiments.

User device 110, service provider server 120, payment provider server 130, and marketing server 140 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160.

User device 110 may be implemented using any appropriate hardware and software configured for wired and/or wireless communication over network 160. For example, user device 110 may be implemented as a personal computer (PC), a smart phone, personal digital assistant (PDA), laptop computer, and/or other types of computing devices capable of transmitting and/or receiving data, such as an IPAD® from APPLE®. Although a user device is shown, the user device may be managed or controlled by any suitable processing device. Although only one user device is shown, a plurality of user devices may be utilized.

User device 110 of FIG. 1 contains a browser application 112, other applications 114, identifiers 116, and a network interface component 118. Browser application 112 and other applications 114 may correspond to processes, procedures, and/or applications executable by a hardware processor, for example, a software program. In other embodiments, user device 110 may include additional or different software as required.

Browser application 112 may be used, for example, to provide a convenient interface to permit a user to browse information available over network 160 and establish, maintain, and utilize user accounts available on service providers. In one embodiment, browser application 112 may be implemented as a web browser configured to view information available over the Internet or access a website of a service provider. Browser application 112 may be utilized to access marketplace websites and engage in online transactions. Additionally, browser application 112 may access other service provider websites, such as a payment provider, to facilitate online payments, financial websites to view financial information and engage in financial transactions, messaging websites, social networking websites, and/or other online actions.

Browser application 112 may further be utilized to establish, access, and maintain user accounts and engage in online transactions using the user account. For example, browser application 112 may be utilized to establish one or more user accounts with a merchant, a payment provider, a financial institution, an email account provider, a social networking provider, or other service provider. Browser application 112 may access the service provider to utilize and/or maintain the user accounts. The user accounts may interact with other service providers, for example, by facilitating online transactions, transmitting and receiving email messages, or other online transaction. User 102 may utilize browser application 112 to transmit and store information with the user accounts, such as personal information, banking information, and other information. Additionally, the provider of the user account may receive other user information corresponding to the user accounts, such as an IP address, machine cookie, or other user account related information when user 102 establishes or utilized the user account.

In various embodiments, user device 110 includes other applications 114 as may be desired in particular embodiments to provide features to user device 110. For example, other applications 114 may include security applications for implementing client-side security features, programmatic client applications for interfacing with appropriate application programming interfaces (APIs) over network 160, or other types of applications. Other applications 114 may also include email, texting, voice, and/or IM applications that allow a user to send and receive emails, calls, texts, and other notifications through network 160. Other applications 114 may contain software programs, such as a graphical user interface (GUI), executable by a processor that is configured to provide an interface to the user.

User device 110 may further include identifiers 116 which may include, for example, identifiers such as operating system registry entries, cookies associated with browser application 112, identifiers associated with hardware of user device 110, or other appropriate identifiers, such as identifiers used for payment/user/device authentication and/or identification. In one embodiment, identifiers 116 may be used by a service provider, such as service provider server 120 and/or payment provider server 140, to associate user 102 with a particular account maintained by the service provider.

In various embodiments, user device 110 includes at least one network interface component (NIC) 118 adapted to communicate with network 160 including service provider server 120, payment provider server 130, and/or marketing server 130. In various embodiments, network interface component 118 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Service provider server 120 may be maintained, for example, by a service provider offering a service for user 102. In various embodiments, service provider server 120 corresponds generally to an email account and service provider, such as a web-based or client-side email provider, for example MICROSOFT OUTLOOK®, GOOGLE GMAIL®, and YAHOO! MAIL®. Service provider server 120 may correspond to a social networking provider including social networking accounts with user information. Service provider server 120 may correspond generally to a merchant or seller offering various items, products, and/or services through an online site or application and be maintained by anyone or any entity that receives money, which includes charities as well as retailers and restaurants. In this regard, service provider server 120 may include processing applications, which may be configured to interact with user device 110 and/or payment provider server 130 over network 160 to facilitate the sale of products, goods, and/or services. In one example, service provider server 120 may be provided by Ebay®, Inc. of San Jose, Calif., USA. However, service provider server 120 may correspond generally to any service provider offering services utilized by user 102 and maintaining user accounts corresponding to user 102.

Service provider server 120 includes a service application 122, other applications 124, user accounts 126, and a network interface component 128. Service application 122 and other applications 124 may correspond to processes, procedures, and/or applications executable by a hardware processor, for example, a software program. In other embodiments, service provider server 120 may include additional or different software as required

Service provider server 120 includes service application 122, which may be configured to interact with user device 110, payment provider server 130, and/or marketing server 140 over network 160. In one embodiment, service application 122 may correspond to a web-based or client-side email provider, for example MICROSOFT OUTLOOK®, GOGGLE GMAIL®, and YAHOO! MAIL®. Service application 112 may allow a user to access an email account in order to transmit and receive emails. Thus, service application 112 may include an email interface and corresponding processes.

In another embodiment, service application 122 may correspond to a marketplace application on a marketplace server enabling a user to view and purchase various items available, for example Ebay®, Inc. of San Jose, Calif., USA. Thus, service applications 122 may include a marketplace interface displayable on user device 110. Service application 122 may facilitate the exchange of money for items using user device 110 and/or payment provider server 130. More generally, service application 122 may provide a service to user 102 over network 160.

In various embodiments, service provider server 120 includes other applications 124 as may be desired in particular embodiments to provide features for service provider server 120. For example, other applications 124 may include security applications for implementing server-side security features, programmatic server applications for interfacing with appropriate application programming interfaces (APIs) over network 160, or other types of applications. Other applications 124 may also include a payment/checkout application configured to accept payment of items selected by a user through service application 122. Other applications 124 may contain software programs, such as a graphical user interface (GUI), executable by a processor that is configured to provide an interface to the user.

Service provider server 120 includes user accounts 126 including established user accounts and corresponding user information. User accounts 126 may include user information, such as name, address, birthdate, payment/funding information, and/or other desired user data. User accounts 126 may correspond to an email address and mailbox for exchange of emails. User accounts 126 may correspond to social networking accounts. In other embodiments, user accounts 126 may correspond to a merchant purchasing account or other online user account for purchasing items for a merchant. More generally, user accounts 126 correspond to an account established by a user and maintained for engaging in online transactions. User accounts 126 may actively request information, allow a user to submit information, or may retrieve information corresponding to user 102 and/or user device 110, such as by monitoring IP addresses used to access the user account, locations of access, machine cookies, or other user and/or device specific data.

In various embodiments, service provider server 120 includes at least one network interface component (NIC) 128 adapted to communicate with network 160 including user device 110, payment provider server 130, and/or marketing server 140. In various embodiments, network interface component 128 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Payment provider server 130 may be maintained, for example, by an online payment service provider, which may provide processing for online financial transactions on behalf of a user with a merchant. In this regard, payment provider server 130 includes one or more processing applications which may be configured to interact with user device 110 and service provider server 120 over network 160 to facilitate transaction between user device 110 and service provider server 120 or another service provider. In one example, payment provider server 130 may be provided by PayPal®, Inc. of San Jose, Calif., USA. However, in other embodiments, payment provider server 130 may be maintained by a financial services provider, banking institution, and/or other financial provider, which may provide financial services to user 102.

Payment provider server 130 of FIG. 1 includes a transaction processing application 132, other applications 134, user accounts 136, and a network interface component 138. Transaction processing application 132 and other applications 134 may correspond to processes, procedures, and/or applications executable by a hardware processor, for example, a software program. In other embodiments, payment provider server 130 may include additional or different software as required.

Payment provider server 130 includes transaction processing application 132, which may be configured interact with browser application 112 of user device 110 over network 160 to facilitate payments to service provider server 120. In various embodiments, transaction processing application 132 includes features to receive a request to issue a payment and effectuate the payment to service provider server 120 for an item and/or service. However, in various embodiments, transaction processing application 132 may correspond to financial applications configured to view and manage financial assets, such as a banking application. For example, user 102 may utilize transaction processing application to view bank account statements, make online payments, manage assets, and engage in other online financial transactions.

Payment provider server 130 includes other applications 134 as may be desired in particular embodiments to provide features to payment provider server 130. For example, other applications 134 may include security applications for implementing server-side security features, programmatic server applications for interfacing with appropriate application programming interfaces (APIs) over network 160, or other types of applications. Other applications 134 may contain software programs, such as a graphical user interface (GUI), executable by a processor that is configured to provide an interface to a user.

Payment provider server 130 includes user accounts 136 including established user accounts and corresponding user information. User accounts 136 may include user information, such as name, address, birthdate, payment/funding information, and/or other desired user data. User accounts 136 may correspond to a financial user account including information for engaging in online financial transaction, such as online payments, asset management, and/or other financial transaction. More generally, user accounts 136 correspond to an account established by a user and maintained for engaging in online transactions. User accounts 136 may actively request information, allow a user to submit information, or may retrieve information corresponding to user 102 and/or user device 110, such as by monitoring IP addresses used to access the user account, locations of access, machine cookies, or other user and/or device specific data.

In various embodiments, payment provider server 130 includes at least one network interface component (NIC) 138 adapted to communicate with network 160 including user device 110, service provider server 120, and/or marketing server 130. In various embodiments, network interface component 138 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Marketing server 140 may be maintained, for example, by a marketing entity, which may provide marketing opportunities to vendors by linking user accounts with the same or similar characteristics across one or multiple domains to facilitate the transmission of advertisements, coupons, sale offers, or other marketing opportunities to user 102. In this regard, marketing serer 140 may including one or more account linking applications and marketing applications to collect user accounts into account clusters and transmit information to the user accounts included in the account clusters. While marketing server 140 is shown separate from service provider server 120 and payment provider server 130, it is understood the services provided by marketing server 140 may be incorporated within one or both of service provider server 120 and/or payment provider server 130.

Marketing server 140 includes an account linking application 142, marketing application 144, other applications 146, database 150, and a network interface component 148. Account linking application 142, marketing application 144, and other applications 124 may correspond to processes, procedures, and/or applications executable by a hardware processor, for example, a software program. In other embodiments, marketing server 140 may include additional or different software as required

Marketing server 140 includes an account linking application 142, which may be configured to receive an account characteristic corresponding to a user account and find additional user accounts sharing the account characteristic. Thus, account linking application 142 may be configured to interact with service provider server 120, payment provider server 130, and any other user account provider over network 160. Account linking application 142 may receive an account characteristic input, for example, from an administrator of marketing server 140, or link accounts based on a set of predetermined account characteristics. The account characteristics may correspond to user specific and/or device specific information. For example, the account characteristic may correspond to credit card information, debit card information, physical location (e.g. a home address, city, and/or country), and/or bank account information, which may be entered by a user when setting up and/or managing a user account with service provider server 120 and/or payment provider server 130. Additionally, the account characteristic may correspond to other information obtained from user device 110 when user 102 establishes, maintains, or utilizes a user account, such as an IP address of a device used to access the user account and/or a machine cookie. The account characteristic may also correspond to online transactions engaged in by the user account, for example, purchases of items from one or more user accounts established on service provider server 120 with one or more user accounts on payment provider server 130.

Based on the account characteristics, account linking application 142 may search for other accounts sharing the characteristic. The other accounts may belong to the same user, for example, accounts sharing the same personal information, financial information or other user specific characteristic. However, in other embodiments, the accounts may belong to a plurality of users sharing the characteristic, such as IP address (where a plurality of users may access a plurality of accounts belonging to each user using one IP address), account actions, or other non-user specific characteristic. Account linking application 142 may limit the search for user accounts sharing the characteristic to one domain or may broaden to multiple domains. Account linking application 142 may collect user accounts sharing the same or similar account characteristic into an account cluster. In various embodiments, account linking application 142 may utilize more than one account characteristic to determine the account cluster.

Account linking application 142 may further determine account characteristics from an account cluster. For example, user accounts sharing a common credit card may share additional information, such as transaction times, amounts, or specific items. Using the additional account characteristics, further account clusters may be determined. Account linking application 142 may request verification that one or more of the user accounts in an account cluster belong to the same user, such as user 102. In certain embodiments, account linking application 142 may provide additional services, such as enabling/disabling features/transactions associated with the user account or enabling/disabling the user account(s).

Marketing server 140 includes marketing application 144, which may provide marketing opportunities to vendors based on the account clusters. Service provider server 120, payment provider server 130, or other vendor, may desire to transmit advertisements, coupons, sale offers, or other marketing strategy to members of an account cluster based on the account characteristic. Marketing application 144 may therefore transmit targeted marketing to the user accounts in an account cluster, such as coupons to stores local to the user accounts based on a shared address, sale offers based on specific credit cards or banking institutions, and/or other marketing strategy specific to the account characteristic.

In various embodiments, marketing server 140 includes other applications 146 as may be desired in particular embodiments to provide features for marketing server 140. For example, other applications 146 may include security applications for implementing server-side security features, programmatic server applications for interfacing with appropriate application programming interfaces (APIs) over network 160, or other types of applications. Other applications 146 may contain software programs, such as a graphical user interface (GUI), executable by a processor that is configured to provide an interface to the user.

Marketing server 140 includes database 150, which may be configured to store user account identifiers, account characteristics, and/or account clusters, including corresponding account information. Database 150 may further include information corresponding to account clusters determined from the account cluster as previously discussed. Database 150 may be utilized in predicting further account cluster based on shared account characteristics.

In various embodiments, marketing server 140 includes at least one network interface component (NIC) 148 adapted to communicate with network 160 including user device 110, service provider server 120, and/or payment provider server 130. In various embodiments, network interface component 148 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 160 may be implemented as a single network or a combination of multiple networks. For example, in various embodiments, network 160 may include the Internet or one or more intranets, landline networks, wireless networks, and/or other appropriate types of networks. Thus, network 160 may correspond to small scale communication networks, such as a private or local area network, or a larger scale network, such as a wide area network or the Internet, accessible by the various components of system 100.

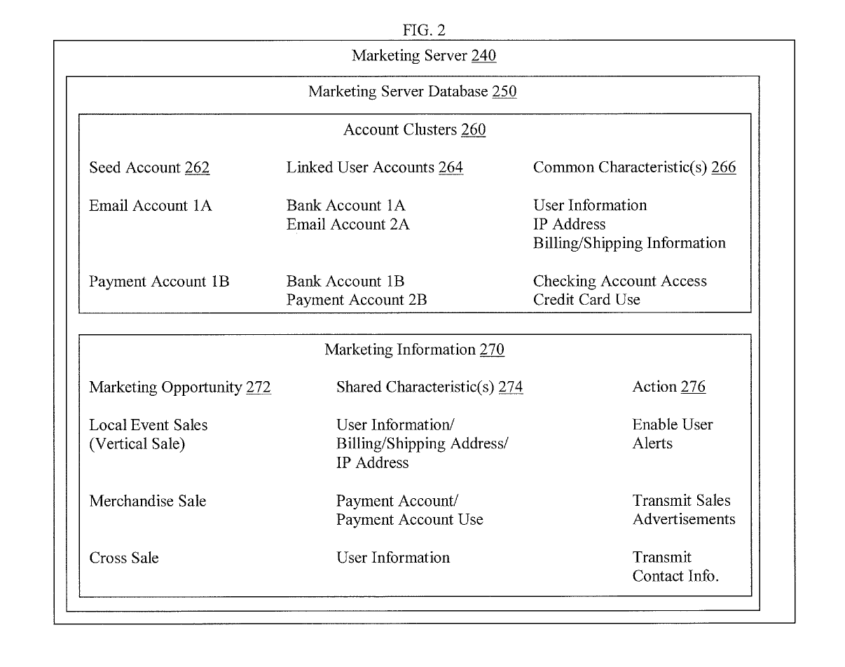

FIG. 2 is a marketing server database including account clusters with shared characteristics. FIG. 2 shows an exemplary database containing account clusters and corresponding information. Marketing server 240 of FIG. 2 includes a marketing server database 250. Marketing server 240 and marketing server database 250 may correspond generally to marketing server 140 and database 150 of FIG. 1. As previously discussed, marketing server 240 may correspond to a separate server providing marketing opportunities to vendors based on account clusters, or marketing server 250 may be incorporated within another service provider server.

Marketing server database 250 of FIG. 2 includes two data clusters corresponding to account clusters 260 and marketing information 270. Account clusters 260 and marketing information 270 correspond to data structures of marketing database 250 residing in a memory of marketing server 240. In other embodiments, marketing server database 250 may include more or different data structures as necessary for the operations of marketing server 240 as described herein.

Account clusters 260 include seed account 262, linked user accounts 264, and common characteristic(s) 264. Seed account 262 may correspond to a first user account possessing an account characteristic. As previously discussed, the account characteristic may correspond to credit card information, debit card information, physical location (e.g. a home address, city, and/or country), bank account information, an IP address of a device used to access the user account, a machine cookie, online transactions engaged in by the user account (i.e. purchases of items from a user account established on service provider server 120 with a user account on payment provider server 130), or other account characteristic. The account characteristic may be derived from previously generated account clusters. Seed account 262 may be an account possessing the account characteristic, with which marketing server 240 is interested in forming an account cluster in account clusters 260. Thus, as shown in FIG. 2, seed accounts 262 include email account 1A and payment account 1B. Seed accounts 262 may correspond generally to user accounts 126 and/or user accounts 136 established on service provider server 120 and/or payment provider server 130, respectively.

Linked user accounts 264 of account clusters 260 correspond to user accounts linked to seed account 262 through common characteristic(s) 266. Common characteristic(s) 266 correspond to the previously discussed account characteristics above. Common characteristic(s) 266 correspond to the desired account characteristic used to find linked user accounts 264. Thus, common characteristic(s) 266 may be set by an administrator of marketing server 240, through predetermined settings corresponding to seed account 262 and/or a type of seed account 262, or other method. As shown in FIG. 2, common characteristic(s) 266 of email account 1A correspond to user information (e.g. name, address, social security number, telephone number, or other personal information), IP address, and billing/shipping information, while common characteristic(s) 266 of payment account 1B (e.g. a bank account or payment provider account provided by a payment service provider, for example, PayPal®, Inc. of San Jose, Calif., USA) correspond to checking account access and credit card use.

Using common characteristic(s) 266, linked user accounts 264 are determined Email account 1A of seed account 262 is linked to bank account 1A and email account 2A of linked user accounts 264 through user information and IP address. Additionally, payment account 1B of seed account 262 is linked to bank account 1B and payment account 2B of linked user accounts 264 through checking account access and credit card use. In various embodiments, account clusters 260 may contain additional and/or different seed account 262, linked user accounts 264, and/or common characteristic(s) 266.

As previously discussed, linked user accounts 264 may belong to the same user, for example accounts sharing the same personal information, financial information or other user specific characteristic. Thus, common characteristic(s) 266 and/or other setting may limit linked user accounts 264 to a single user, for example linking all accounts belonging to one user that share a characteristic. However, in other embodiments, linked user accounts 264 may belong to a plurality of users sharing the characteristic, such as IP address (where a plurality of users may access a plurality of accounts belonging to each user), account actions, or other non-user specific characteristic. Thus, linked user accounts 264 may belong to a plurality of users, or may include a plurality of accounts belonging to one user with accounts belonging to other users.

Marketing server database 250 further includes marketing information 270. Marketing information 270 may include information of advertisements, coupons, offers of sale, and other marketing opportunities that may be directed to a user account. Marketing information 270 may be received from vendors, such as a merchant, advertiser, or other outside vendor, or may be aggregated by marketing server 240 using common search techniques.

Marketing information 270 includes marketing opportunities 272. Marketing opportunities 272 may correspond generally to marketing strategies utilized to convey advertisements, coupons, sale offers, or other marketing strategy to users. Marketing opportunities 272 may be user account and/or user specific, or may factor in other information, such as data included in common characteristic(s) 266. Marketing opportunities 272 may include cross and/or vertical sales. As shown in FIG. 2, marketing opportunities 272 correspond to local event sales and a merchandise sale.

As discussed above, marketing opportunities 272 may be user account and/or user specific, for example, using shared characteristic(s) 274. Shared characteristic(s) 274 may correspond generally to common characteristic(s) 266, for example, using credit card information, debit card information, physical location (e.g. a home address, city, and/or country), bank account information, an IP address of a device used to access the user account, a machine cookie, online transactions engaged in by the user account, or other account characteristic.

Shared characteristic(s) 264 may be used to target marketing strategies to specific audiences (e.g. a vertical sale opportunity to a specific industry or group). However, in various embodiments, shared characteristic(s) 264 may correspond to more general characteristics or no characteristic, when using advertisements applicable to a wide audience. As shown in FIG. 2 local event sales of marketing opportunity 272 corresponds to user information/IP address in shared characteristic(s) 274, while merchandise sale of marketing opportunity 272 corresponds to payment account/payment account use of shared characteristic(s) 274. Additionally, cross sale opportunities are available between users depending on shared characteristics.

When one or more of shared characteristic(s) 274 is met using common characteristic(s) 266, marketing server 240 may utilize a corresponding marketing opportunity 272 based on action 276. Action 276 may correspond to an action taken by marketing server 240 when one or more of shared characteristic(s) 274 is met by on of account clusters 260. Action 276 may correspond to transmitting marketing opportunity 272 to a set of user accounts in one of account cluster 260 or may correspond to different or additional actions. As shown in FIG. 2, when a local event sale opportunity occurs, user alerts are enabled, when a merchandise sale opportunity occurs, sales advertisements are transmitted, and when a cross sale opportunity occurs, contact information is transmitted.

Thus, using marketing server database 250, account clusters 260 may be formed from seed account 262 and common characteristic(s) 266 to find linked user accounts 264. Then, by matching common characteristic(s) 266 to shared characteristic(s) 274, one or more of marketing opportunities 272 may be taken based on their corresponding action 276. In this way, marketing opportunities may be served to account clusters.

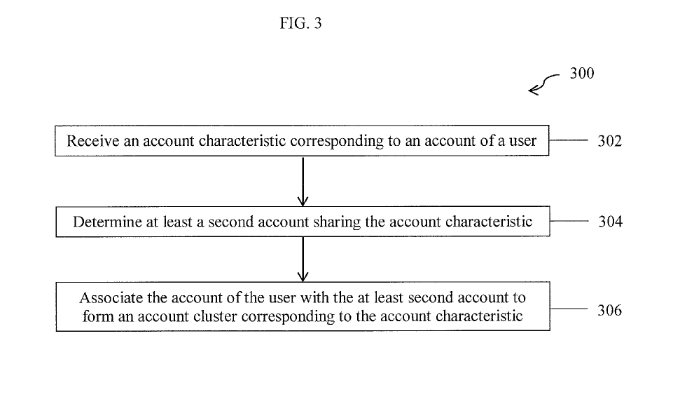

FIG. 3 is a flowchart of an exemplary process by a marketing server for marketing opportunities to account clusters with shared characteristics. Note that one or more steps, processes, and methods described herein may be omitted, performed in a different sequence, or combined as desired or appropriate.

At step 302, an account characteristic corresponding to an account of a user is received by a server, for example marketing server 140/240. The account characteristic may correspond generally to common characteristic(s) 266, for example, credit card information, debit card information, physical location (e.g. a home address, city, and/or country), billing/shipping address, bank account information, an IP address of a device used to access the user account, a machine cookie, online transactions engaged in by the user account, or other account characteristic.

The server may receive the account characteristic and corresponding account through input, such as an administrator input. In such an embodiment, a server administrator may choose the account characteristic and corresponding seed account (e.g. one of seed account 262). In other embodiments, account characteristics may be predetermined, e.g. an account characteristic is chosen and seed accounts searched for depending on the account characteristic. Still further, account characteristics may be determined through analysis of account clusters 260, and similar account clusters found based on the determined account characteristics.

Once an account characteristic and corresponding seed account are determined, at step 304 at least a second account sharing the account characteristic is determined Marketing server 140/240 may determine the at least second account based on a search of a single domain or multiple domains. For example, in one domain, multiple accounts may share a common physical address, IP address, or credit card information. Thus, an account cluster may be made corresponding to the one domain. However, in other embodiments, multiple domains may be searched based on the same account characteristic, or different account characteristic, such as utilizing a user account on one domain with multiple user accounts on another domain (e.g. utilizing one merchant account on a merchant server to purchase items with multiple payment accounts on a payment provider server).

The at least second account may belong to the same user, for example, accounts sharing the same personal information, financial information or other user specific characteristic. However, in other embodiments, the at least second account may belong to a plurality of users sharing the characteristic, such as IP address (where a plurality of users may access a plurality of accounts belonging to each user), account actions, or other non-user specific characteristic. Thus, the account of a user and the at least second account may belong to a plurality of users, or may include a plurality of accounts belonging to one user and accounts belonging to other users.

At step 306, the account of the user and the at least second account are associated to form an account cluster corresponding to the account characteristic. The account cluster may include all user accounts sharing the account characteristic across one or multiple searched domains. Thus, the account cluster provides information of linked accounts based on shared characteristics.

The account cluster may be further broadened and/or narrowed by including additional account characteristics, or narrowing the account characteristics used. For example, the physical address and shared address could be utilized as search characteristics, wherein the accounts must share both account characteristics, to provide a narrower search. However, to receive more potential accounts, the account cluster may only require that the found accounts share one of the two account characteristics.

After collecting the user accounts into an account cluster, further actions may be taken by the server. In various embodiments, the server may enable or disable one or more of the accounts and/or features associated with one or more of the accounts. The server may request verification that one or more of the corresponding accounts belong to the same user as the seed account. The account cluster may be analyzed to determine one or more behaviors, where the behaviors are utilized to determine further account clusters.

In certain embodiments, marketing opportunities may be transmitted to the user accounts of the account cluster. The marketing opportunities may be based on the account characteristic or an additional characteristic and/or behavior of the account cluster. The marketing opportunities may include, for example, an advertisement, a coupon, and a sale offer.

In various embodiments, a predictive model and/or ranking algorithm may be utilized to determine the likelihood that user accounts in an account cluster may accept a marketing/advertising strategy containing advertisements, coupons, and/or offers for sale based on the account characteristic and the marketing/advertising strategy. Thus, a score may be determined based on the account characteristic defining the account cluster, and the marketing strategy. A threshold may be applied to the score to determine if the marketing strategy is compatible with the account cluster. For example, if the score meets a threshold of 0.8, then user accounts in the account cluster may accept or would be open to the particular marketing strategy, however, lower score values may prevent utilizing the particular marketing strategy on the user accounts in the account cluster.

This predictive model may adopt a tiered approach, where after determining the marketing strategy is compatible with an account cluster, a predictive score is applied to each advertisement, coupon, offer for sale, or other marketing opportunity in the marketing strategy and the particular user accounts in the account cluster. Thus, an advertisement with a score of 0.9 for first user account may be transmitted to the first user account, where the same advertisement with a score of 0.5 for a second user account is not transmitted to the second user account. Likewise, while the advertisement may be transmitted to the first user account, a coupon with a score of 0.4 for the first user account may not be transmitted to the first user account. The tiered approach as well as the threshold may be set by the user or a server/network administrator. Thus, the predictive model views the advertisement, coupon, and/or offer for sale, takes the user account as input, and renders a numerical score output that is used to optimize the marketing strategies effectiveness.

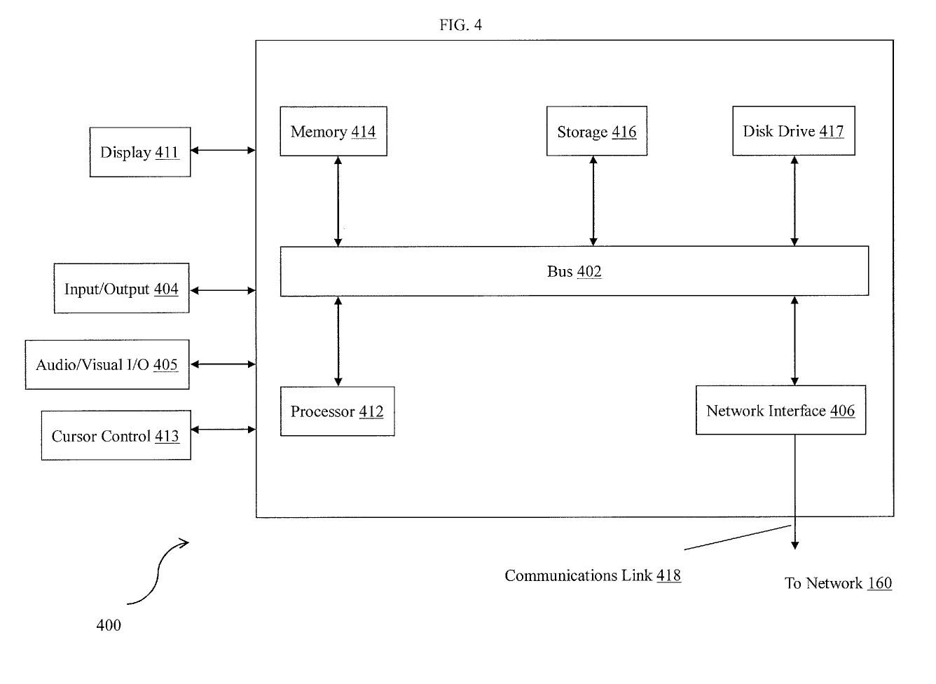

FIG. 4 is a block diagram of a computer system 400 suitable for implementing one or more embodiments of the present disclosure. In various embodiments, the user device may comprise a personal computing device (e.g., smart phone, a computing tablet, a personal computer, laptop, PDA, Bluetooth device, key FOB, badge, etc.) capable of communicating with the network. The merchant server and/or service provider may utilize a network computing device (e.g., a network server) capable of communicating with the network. It should be appreciated that each of the devices utilized by users and service providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons, image, or links, and/or moving one or more images, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as another user device, a merchant server, or a service provider server via network 160. In one embodiment, the transmission is wireless, although other transmission mediums and methods may also be suitable. One or more processors 412, which can be a micro-controller, digital signal processor (DSP), or other processing component, processes these various signals, such as for display on computer system 400 or transmission to other devices via a communication link 418. Processor(s) 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor(s) 412 and other components by executing one or more sequences of instructions contained in system memory component 414. Logic may be encoded in a computer readable medium, which may refer to any medium that participates in providing instructions to processor(s) 412 for execution. Such a medium may take many forms, including but not limited to, non-volatile media, volatile media, and transmission media. In various embodiments, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory storing user account information, wherein the user account information comprises account clusters; and
one or more hardware processors in communication with the non-transitory memory and configured to:
receive an account characteristic corresponding to an account of a user;
determine at least a second account sharing the account characteristic; and
associate the account of the user with the at least second account to form an account cluster corresponding to the account characteristic.

2. The system of claim 1, wherein the one or more hardware processors is further configured to
enable or disable a feature associated with the account cluster

3. The system of claim 1, wherein the account characteristic is one of an email server, a physical location, an IP address, a machine cookie, a bank account, and a payment card number.

4. The system of claim 1, wherein the one or more hardware processors is further configured to:
determine if the account of the user and the at least second account belong to the user.

5. The system of claim 1, wherein the one or more hardware processors is further configured to:
transmit at least one of an advertisement, a coupon, and a sale offer to the account of the user and the at least second account.

6. The system of claim 1, wherein the one or more hardware processors is further configured to:
determine a first predictive score for the account cluster based on the account characteristic and an marketing strategy including at least one of an advertisement, a coupon, and a sale offer;
if the first predictive score meets or exceeds a first threshold, determine a second predictive score based on the account of the user and the at least one of the advertisement, the coupon, and the sale offer;
if the second predictive score meets or exceeds a second threshold, transmit the at least one of the advertisement, the coupon, and the sale offer to the account of the user.

7. The system of claim 1, wherein the one or more hardware processors is further configured to:
disable the account of the user and the at least second account.

8. The system of claim 1, wherein the one or more hardware processors is further configured to:
determine a second account cluster based on a behavior of the account cluster.

9. A method comprising:
receiving an account characteristic corresponding to an account of a user;
determining at least a second account sharing the account characteristic;
associating, using a hardware processor of a server, the account of the user with the at least second account to form an account cluster corresponding to the account characteristic; and
transmitting at least one of an advertisement, a coupon, and a sale offer to the account of the user and the at least second account.

10. The method of claim 9 further comprising:
enabling or disabling a feature associated with the account cluster.

11. The method of claim 9, wherein the account characteristic is one of an email server, a physical location, an IP address, a machine cookie, a bank account, and a payment card number.

12. The method of claim 9 further comprising:
determining if the account of the user and the at least second account belong to the user.

13. The method of claim 9 further comprising:
transmitting at least one of an advertisement, a coupon, and a sale offer to the account of the user and the at least second account.

14. The method of claim 9 further comprising:
determining a second account cluster based on a behavior of the account cluster.

15. A non-transitory computer readable medium comprising a plurality of machine-readable instructions which when executed by one or more processors of a server are adapted to cause the server to perform a method comprising:
receiving an account characteristic corresponding to an account of a user;
determining at least a second account sharing the account characteristic;
associating the account of the user with the at least second account to form an account cluster corresponding to the account characteristic; and
transmitting at least one of an advertisement, a coupon, and a sale offer to the account of the user and the at least second account.

16. The non-transitory computer readable medium of claim 15, wherein the method further comprises:
enabling or disabling a feature associated with the account cluster.

17. The non-transitory computer readable medium of claim 15, wherein the account characteristic is one of an email server, a physical location, an IP address, a machine cookie, a bank account, and a payment card number.

18. The non-transitory computer readable medium of claim 15, wherein the method further comprises:
determining if the account of the user and the at least second account belong to the user.

19. The non-transitory computer readable medium of claim 15, wherein the method further comprises:
transmitting at least one of an advertisement, a coupon, and a sale offer to the account of the user and the at least second account.

20. The non-transitory computer readable medium of claim 15, wherein the method further comprises:
determining a second account cluster based on a behavior of the account cluster.
